(19) United States
(12) Patent Application Publication
(10) Pub. No.: US 2018/0208049 A1
(43) Pub. Date: Jul. 26, 2018

(54) FLUSH-MOUNTED ACTIVE GRILLE SHUTTER SYSTEM

(71) Applicant: FORD GLOBAL TECHNOLOGIES, LLC, Dearborn, MI (US)

(72) Inventors: Aaron Peter Klop, Bloomfield Hills, MI (US); David Brian Glickman, Southfield, MI (US); Robert H. Vasbinder, Dundee, MI (US); Ronald L. Anderson, Newport Beach, CA (US)

(21) Appl. No.: 15/413,499

(22) Filed: Jan. 24, 2017

(51) Int. Cl. B60K 11/08; B60R 19/52

(52) U.S. Cl. CPC B60K 11/085; B60R 2019/525; B60R 19/52

(57) ABSTRACT

A flush-mounted active grille shutter system includes a grille defining a plurality of airflow openings and including a plurality of bushings and a translatable blocking member translatable along guide slots defined by the plurality of bushings between an open position exposing the plurality of airflow openings and a closed position blocking the plurality of airflow openings. An actuator bracket carries an actuator configured to translate the translatable blocking member between the open position and the closed position. The actuator may be a rotary actuator. Vehicle grille assemblies and vehicles including the flush-mounted active grille shutter system are described.

### TECHNICAL FIELD

This disclosure relates generally to grille shutters and actuators for opening and closing vehicle grille openings.

### BACKGROUND

Active grille shutter (AGS) systems, according to their orientation, provide a controlled cooling airflow from the vehicle exterior to control heat build-up and reduce aerodynamic drag. AGS systems typically comprise a plurality of louvers, vanes, or shutters which can be variously oriented between a fully opened configuration and a fully shut configuration to control of the amount of exterior air entering the engine compartment and/or passing over elements of the vehicle drivetrain. Such AGS systems are often used as supplemental cooling systems to increase/decrease exterior airflow into the engine compartment and/or over components of the drivetrain, particularly when a vehicle is in motion.

Conventional active grille shutter systems comprising louvers or shutters are typically provided as pivoting flat vanes packaged behind a styled grille having a compound curved surface that is relatively complex. Alternatively, it is known to provide AGS systems comprising flat panels which are also mounted behind the styled grilles. In such assemblies, the effectiveness of the shutters in reducing aerodynamic drag is reduced, and the packaging space required to accommodate the systems is increased.

Accordingly, a need is identified in the art for improved AGS systems comprising flush mounted airflow blocking structures.

### SUMMARY

In accordance with the purposes and benefits described herein, in one aspect of the present disclosure a flush-mounted active grille shutter system is provided, comprising a grille defining a plurality of airflow openings and including a plurality of bushings and a translatable blocking member. The translatable blocking member is translatable along guide slots defined by the plurality of bushings between an open position exposing the plurality of airflow openings and a closed position blocking the plurality of airflow openings. An actuator bracket is provided, adapted for carrying an actuator configured to translate the translatable blocking member between the open position and the closed position.

In embodiments, the actuator bracket is vertically oriented and includes bracket arms attached to the grille. The translatable blocking member may include a plurality of spaced vanes configured and dimensioned to block the plurality of airflow openings when placed in the closed position. The guide slots may be arcuate guide slots extending rearwardly and vertically away from the grille. The actuator may be a rotary actuator. In embodiments, the translatable blocking member comprises followers configured and dimensioned to travel within the guide slots.

In another aspect, a flush-mounted active grille shutter system is provided, comprising a grille defining a plurality of airflow openings and including a plurality of bushings each defining a guide slot, a translatable blocking member comprising followers translatable along the guide slots between an open position exposing the plurality of airflow openings and a closed position blocking the plurality of airflow openings, and a rotary actuator configured to translate the translatable blocking member. A vertically-oriented bracket is attached to the grille and adapted for carrying the rotary actuator.

In embodiments, the translatable blocking member includes a plurality of spaced vanes configured and dimensioned to block the plurality of airflow openings when placed in the closed position. The rotary actuator is operatively connected to the translatable blocking member by at least one drive arm. The guide slots may be arcuate guide slots extending rearwardly and vertically away from the grille.

In yet another aspect of the disclosure, a grille assembly is provided, comprising a fascia panel defining a grille opening, a grille defining a plurality of airflow openings disposed in the grille opening, a translatable blocking member including a plurality of spaced vanes disposed to block the airflow openings in a flush position, and a rotary actuator operatively connected to the translatable blocking member. A vertically-oriented bracket may be provided, attached to the grille and adapted for carrying the rotary actuator.

In embodiments, the rotary actuator is operatively connected to the translatable blocking member by at least one drive arm. The grille may include a plurality of bushings each defining a guide slot. In embodiments, the guide slots are arcuate guide slots extending rearwardly and vertically away from the grille. In embodiments, the translatable blocking member comprised followers configured and dimensioned to travel within the guide slots.

In the following description, there are shown and described embodiments of the disclosed flush-mounted active grille shutter system. As it should be realized, the devices are capable of other, different embodiments and their several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed flush-mounted active grille shutter system, and together with the description serve to explain certain principles thereof. In the drawings:

FIG. 1 shows a vehicle including a flush-mounted active grille shutter system according to the present disclosure;

FIG. 2 shows a front view of a vehicle grille including a flush-mounted active grille shutter system according to the present disclosure;

FIG. 3 shows a rear view of the vehicle grille of FIG. 2, with the flush-mounted active grille shutter system in a closed position; and

FIG. 4 shows a rear view of the vehicle grille of FIG. 2, with the flush-mounted active grille shutter system in an open position.

Reference will now be made in detail to embodiments of the disclosed active grille shutter system, examples of which are illustrated in the accompanying drawing figures. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

### DETAILED DESCRIPTION

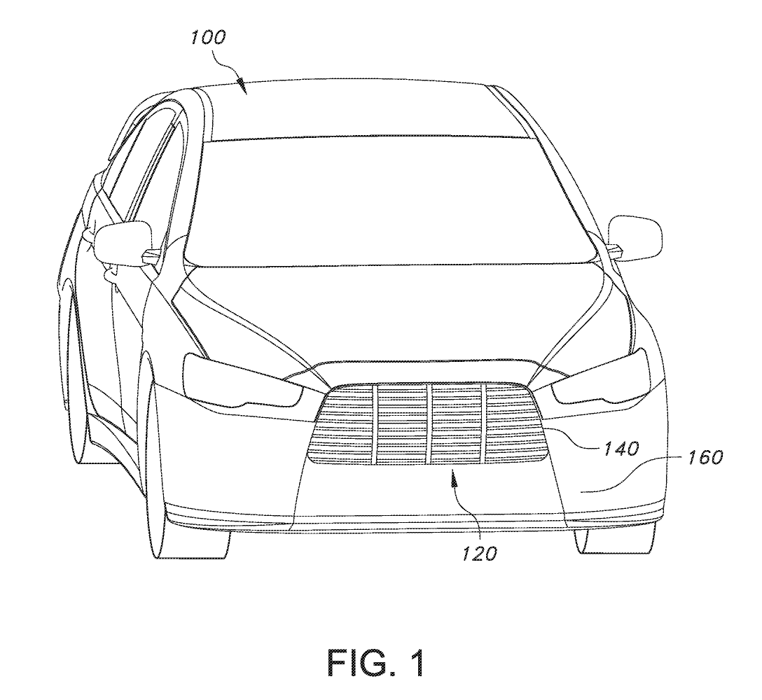

FIG. 1 illustrates a vehicle 100 including a grille 120 held in a grille opening 140 defined in a front fascia panel 160. The grille 120 is backed by a blocking member (not shown in this view) which may be translated between an open position (full airflow allowed) and a closed position (airflow blocked) as will be described in detail.

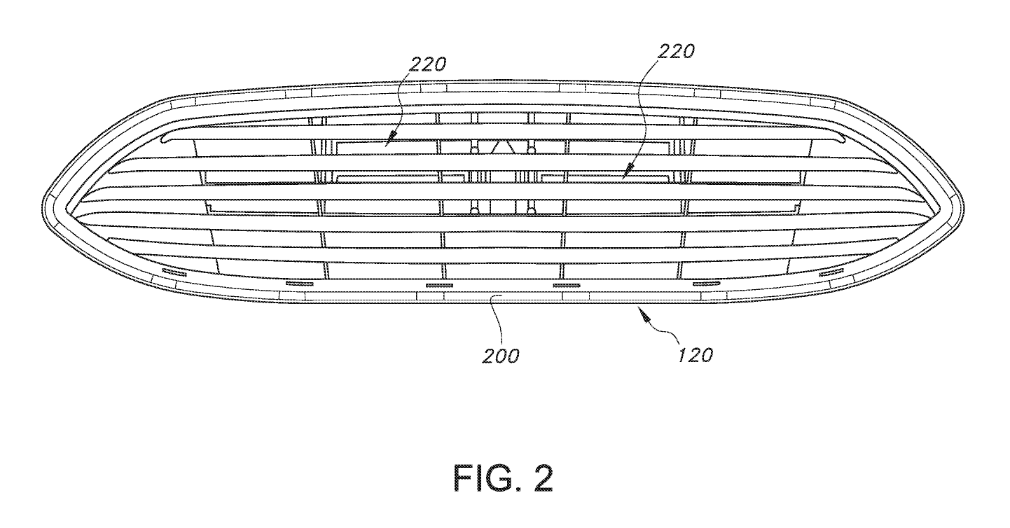

FIG. 2 illustrates the grille 120 in greater detail. In the depicted embodiment, the grille 120 includes a body 200 defining a compound-shape grille and having a plurality of airflow openings 220, which may be of equal or different size from one another. The airflow openings 220 may guide air through an upper channel (not shown) to cool the vehicle 100 engine compartment, and/or may guide air through a lower channel (not shown) to cool elements of the vehicle powertrain. As is known to the skilled artisan, a compound-shape grille arrangement is, at a high level, a grille defining a compound shape wherein all cross sections of its surface are non-linear curves.

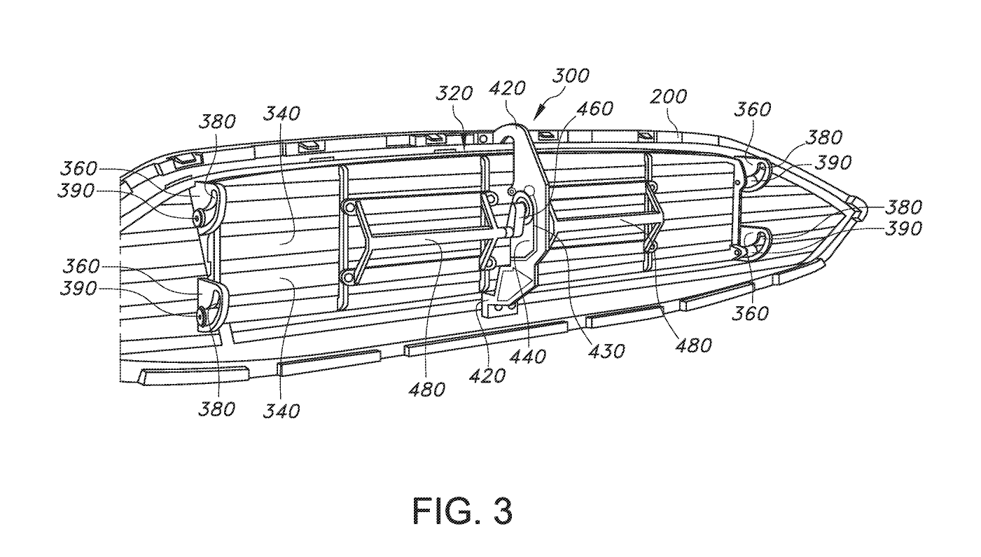

As shown in FIG. 3, a flush-mounted active grille shutter system 300 is associated with the grille body 200. The flush-mounted active grille shutter system 300 comprises a translatable blocking member 320 including a plurality of vanes 340 dimensioned to block airflow through airflow openings 220 when positioned appropriately. Translation of the translatable blocking member 320 is controlled by a plurality of bushings 360 associated with the grille body 200. The bushings 360 may be attached to or integral with the grille body 200. In the depicted embodiment four bushings 360 are provided, with a bushing disposed at each corner of the translatable blocking member 320. However, it will be appreciated that more or fewer bushings 360 may be provided according to the dimensions of the translatable blocking member 320.

Each bushing 360 includes a guide slot 380 defined therein, to define a permissible distance and path of travel of the translatable blocking member 320. The translatable blocking member 320 further includes cooperating followers 390 dimensioned and configured to traverse at least a portion of a length of the guide slots 380 as will be described below

A centrally mounted and vertically oriented actuator bracket 400 is provided including a pair of arms 420 extending from the grille body 200. The actuator bracket 400 may be attached to or integrally formed with the grille body 200. The actuator bracket 400 includes a receiver 430 which carries an actuator 440 and/or actuator housing, in the depicted embodiment being a rotary actuator which rotates at least one drive arm 460. Use of any suitable actuator is contemplated, including without intending any limitation rotary stepper motors, brushless or brush DC motors with position-determining hall-effect sensors, and others. As shown, by the arms 420 the receiver 430 and the actuator 440/actuator housing carried thereby are held at a spaced distance from the grille body 200.

In the depicted embodiment a pair of drive arms 460 are driven by the actuator 440. Each drive arm 460 is operatively connected to the translatable blocking member 320, in the depicted embodiment by way of brackets 480. However, it will be appreciated that the drive arms 460 may be operatively connected to the translatable blocking member 320 by other structures, or indeed may be directly connected to a portion of the translatable blocking member. All such configurations are contemplated.

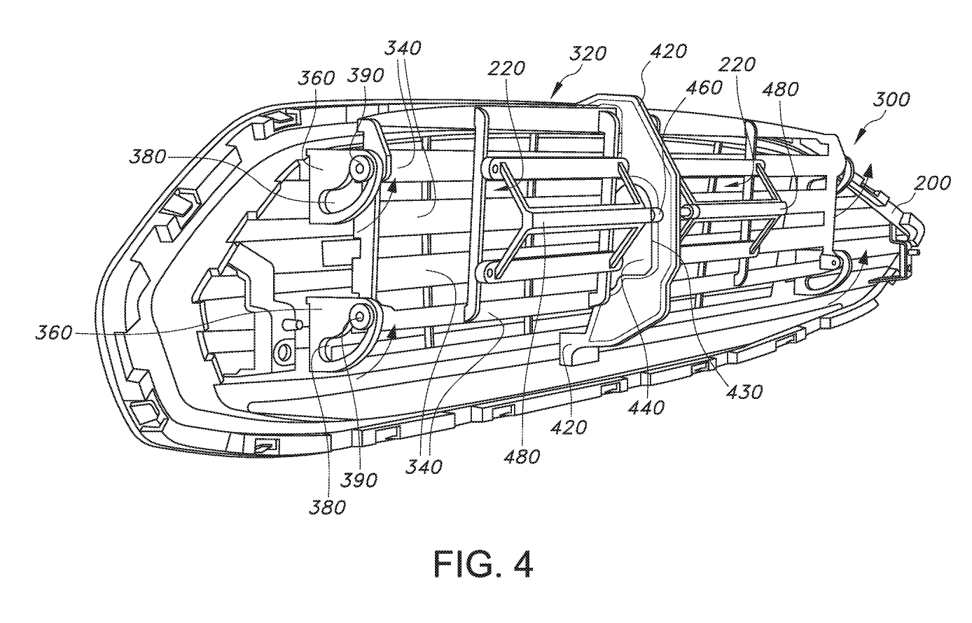

FIG. 3 shows the translatable blocking member 320 in a closed position whereby airflow through the grille body airflow openings 220 is prevented. In use, with reference to FIG. 4, when it is desired to translate the translatable blocking member 320 to an open position whereby full airflow through the grille body airflow openings 220 is allowed, the actuator 440 causes the drive arms 460 to pivot, translating the translatable blocking member upwardly and slightly vehicle-rearwardly (see arrow). Because the arms 420 hold the receiver 430 and the actuator 440/actuator housing carried thereby at a spaced distance from the grille body 200 as described above, this path of travel is possible. The guide slots 380 of the bushings 360 further control the path and distance of travel of the translatable blocking member 320 as it translates to the open position.

In the open position shown in FIG. 4, the vanes 340 of the translatable blocking member 320 have moved sufficiently to expose the grille body airflow openings 220, allowing airflow therethrough.

Embodiments providing a plurality of open positions are contemplated to variably control an amount of airflow allowed through the grille body airflow openings 220. In an embodiment, control of movement of the translatable blocking member 320 by a vehicle controller is contemplated. In an embodiment, the controller may be a vehicle powertrain control module (PCM) and control of the translatable blocking member 320 by the PCM may be effected by a method as set forth in the present assignee's U.S. Pat. No. 8,667,931, the contents of which are incorporated herein by reference as if fully restated.

By implementation of the described flush-mounted active grille shutter system 300, numerous advantages are realized. An active grille shutter system 300 is provided having a clean, flush appearance which efficiently blocks air into a vehicle 100 engine compartment at need, thus reducing aerodynamic drag. By use of the described translatable blocking member 320 driven by a rotary actuator 440/drive arm 460, the translatable blocking member 320 may be moved vehicle-aft and upwardly to articulate around grille bodies 200 including large bars having a significant fore-aft depth in appearance. This is accomplished without occupying packaging space at a centerline of the vehicle 100, which is then freed up for packaging such items as hood latches, etc. In turn, external gearing for translating the translatable blocking member 320 is eliminated.

Still more, the described flush-mounted active grille shutter system 300 is eminently suitable for use with grilles defining a compound-shape grille arrangement. For conventional grille arrangements, reliance is placed on non-compound surfaces for shutter assemblies to pivot or slide to block the grille apertures. For this reason, shutters in conventional grille arrangements must be set back from any compound external surface of a vehicle front, requiring extra parts, extra packaging space requirements, and concomitant extra cost. On the other hand, for the presently described flush-mounted active grille shutter system 300 there is no such requirement for distancing the shutters/translatable blocking member 320 from a compound grille surface, thus reducing the additional parts, packaging space, and cost associated with conventional grill shutter systems.

Obvious modifications and variations are possible in light of the above teachings. All such modifications and variations are within the scope of the appended claims when interpreted in accordance with the breadth to which they are fairly, legally and equitably entitled.

1. A flush-mounted active grille shutter system, comprising:
a grille defining a plurality of airflow openings and including a plurality of bushings; and
a vertically translatable blocking member translatable along guide slots defined by the plurality of bushings between a fully open position exposing the plurality of airflow openings and a fully closed position blocking the plurality of airflow openings.

2. The flush-mounted active grille shutter system of claim 1, further comprising an actuator bracket adapted for carrying an actuator configured to translate the translatable blocking member between the open position and the closed position.

3. The flush-mounted active grille shutter system of claim 2, wherein the actuator bracket is vertically oriented and includes bracket arms attached to the grille.

4. The flush-mounted active grille shutter system of claim 1, wherein the translatable blocking member includes a plurality of spaced vanes configured and dimensioned to block the plurality of airflow openings when placed in the closed position.

5. The flush-mounted active grille shutter system of claim 1, wherein the guide slots are arcuate guide slots extending rearwardly and vertically away from the grille.

6. The flush-mounted active grille shutter system of claim 2, wherein the actuator is a rotary actuator.

7. The flush-mounted active grille shutter system of claim 6, wherein the actuator is a rotary stepper motor, a brushless DC motor, or a brush DC motor.

8. The flush-mounted active grille shutter system of claim 1, wherein the translatable blocking member comprises followers configured and dimensioned to travel within the guide slots.

9. The flush-mounted active grille shutter system of claim 1, wherein the grille defines a compound shape.

10. A flush-mounted active grille shutter system, comprising:
a grille defining a plurality of airflow openings and including a plurality of bushings each defining a guide slot;
a vertically translatable blocking member comprising followers translatable along the guide slots between a fully open position exposing the plurality of airflow openings and a fully closed position blocking the plurality of airflow openings; and
a rotary actuator configured to translate the vertically translatable blocking member.

11. The flush-mounted active grille shutter system of claim 10, further comprising a vertically-oriented bracket attached to the grille and adapted for carrying the rotary actuator.

12. The flush-mounted active grille shutter system of claim 10, wherein the translatable blocking member includes a plurality of spaced vanes configured and dimensioned to block the plurality of airflow openings when placed in the closed position.

13. The flush-mounted active grille shutter system of claim 10, wherein the rotary actuator is operatively connected to the translatable blocking member by at least one drive arm.

14. The flush-mounted active grille shutter system of claim 10, wherein the guide slots are arcuate guide slots extending rearwardly and vertically away from the grille.

15. A grille assembly, comprising:
a fascia panel defining a grille opening;
a grille defining a plurality of airflow openings disposed in the grille opening;
a vertically translatable blocking member including a plurality of spaced vanes disposed to block the airflow openings in a flush position; and
a rotary actuator operatively connected to the vertically translatable blocking member.

16. The grille assembly of claim 15, further comprising a vertically-oriented bracket attached to the grille and adapted for carrying the rotary actuator.

17. The grille assembly of claim 15, wherein the rotary actuator is operatively connected to the translatable blocking member by at least one drive arm.

18. The grille assembly of claim 15, wherein the grille includes a plurality of bushings each defining a guide slot.

19. The grille assembly of claim 18, wherein the guide slots are arcuate guide slots extending rearwardly and vertically away from the grille.

20. The grille assembly of claim 19, wherein the translatable blocking member comprises followers configured and dimensioned to travel within the guide slots.
